(19) United States
(12) Patent Application Publication
(10) Pub. No.: US 2020/0271154 A1
(43) Pub. Date: Aug. 27, 2020

(54) JOURNAL BEARING WITH INDENTED JOURNAL SURFACE

(71) Applicant: Robert Britton, Wichita Falls, TX (US)

(72) Inventor: Robert Britton, Wichita Falls, TX (US)

(21) Appl. No.: 16/787,951

(22) Filed: Feb. 11, 2020

Related U.S. Application Data
(60) Provisional application No. 62/810,411, filed on Feb. 26, 2019.

(51) Int. Cl. F16C 17/10; F16C 9/02

(52) U.S. Cl. CPC F16C 17/10; F16C 9/02

(57) ABSTRACT

A journal bearing for a crankshaft having indentations on the journal surface is disclosed. The indentations are designed to increase lubricant volume and decrease friction between the journal surface and the bearing surface. The indentations may be designed to intensify the hydrodynamic pressure when the crankshaft is rotating.

### CROSS-REFERENCE TO RELATED APPLICATIONS

This application claims priority to U.S. Patent Application No. 62/810,411, filed on Feb. 26, 2019.

### BACKGROUND AND SUMMARY

This invention pertains generally to technology for lubricating journal bearings. More specifically, the invention is directed to an improved bearing and shaft design to facilitate hydrodynamic (full-film) lubrication of an oil-fed friction bearing. For example, the technology can be used to improve crankshaft bearings in an internal-combustion engine.

Journal bearings are often exposed to extreme conditions that cause degradation of the bearing. For example, the main and rod bearings in an internal combustion engine may experience tens of thousands of pounds of force directed in a few square inches while the journals rotate in the bearings thousands of times per minute.

For high-stress applications, like the journal bearings of a crankshaft, the journal surface is typically uniformly smooth to minimize friction and wear. The bearing is often designed to support hydrodynamic lubrication in operation. In such a mode, rotation of the journal within the bearing hydrodynamically separates the journal and bearing surfaces with a thin film of oil. This is meant to reduce friction and the associated wear and tear on the journal and bearing surfaces. The oil pressure due to journal rotation also tends to push the oil away from the surfaces (leakage), so a continuous resupply of oil is required.

While hydrodynamic operation may help alleviate frictional wear and tear, experience with actual wear and tear on crankshaft journals indicates that improvements in lubrication designs are needed. The advantages of such an improvement include, for example, reduced wear and tear on journal and bearing surface and decreased friction during operation (e.g., at startup of the journal rotation). This would decrease friction, improve operational efficiency, lower incidents of failure, and lower maintenance and repair costs.

Applicant discovered that a journal surface having small indentations provides better crankshaft performance than a uniformly smooth journal surface. In one aspect of the invention, a crankshaft includes indentations on the rod or main journals within the journal radiuses. These indentations serve to collect and contain oil in order to increase the oil volume, and the hydrodynamic fluid gap between the bearing and journal surfaces. The indentations may be any of a variety of shapes and sizes. For example, the journal surface may be pitted or the indentations may be relatively elongated and oriented slightly inclined relative to the journal's longitudinal axis or wrapped over a substantial portion of the circumference of the journal surface.

### BRIEF DESCRIPTION OF THE DRAWINGS

These and other features, aspects, and advantages of the present invention will be better understood with reference to the following description, appended claims, and accompanying drawings where:

FIG. 1 is an crankshaft-end view depicting a portion of a crankshaft, showing an exemplary rod journal disposed within a rod bearing.

FIG. 2 is a crankshaft-side view depicting a portion of a crankshaft, showing an exemplary rod journal disposed within a rod bearing.

FIG. 3 is a crankshaft-side view depicting a portion of a crankshaft, showing another exemplary rod journal disposed within a rod bearing.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims.

Except as explicitly defined otherwise, the words and phrases used herein, including terms used in the claims, carry the same meaning they carry to one of ordinary skill in the art as ordinarily used in the art.

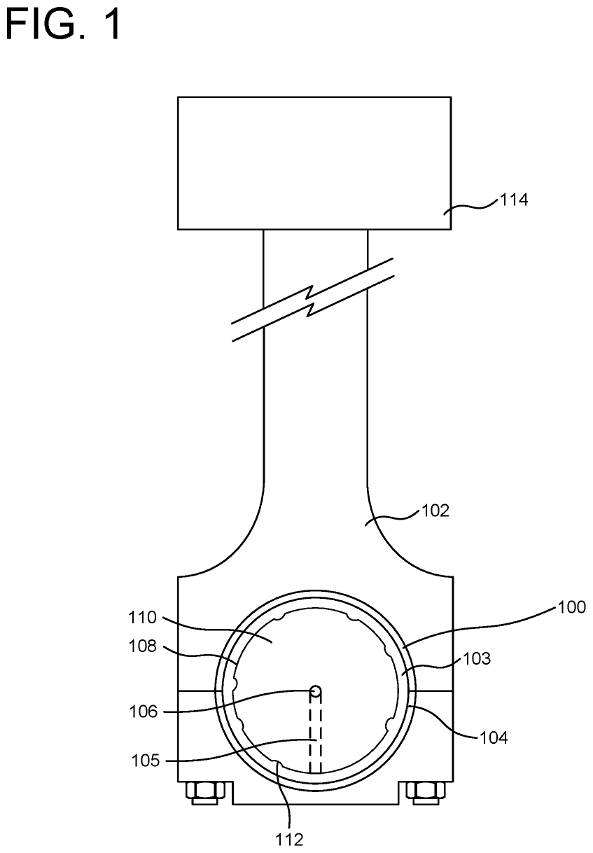

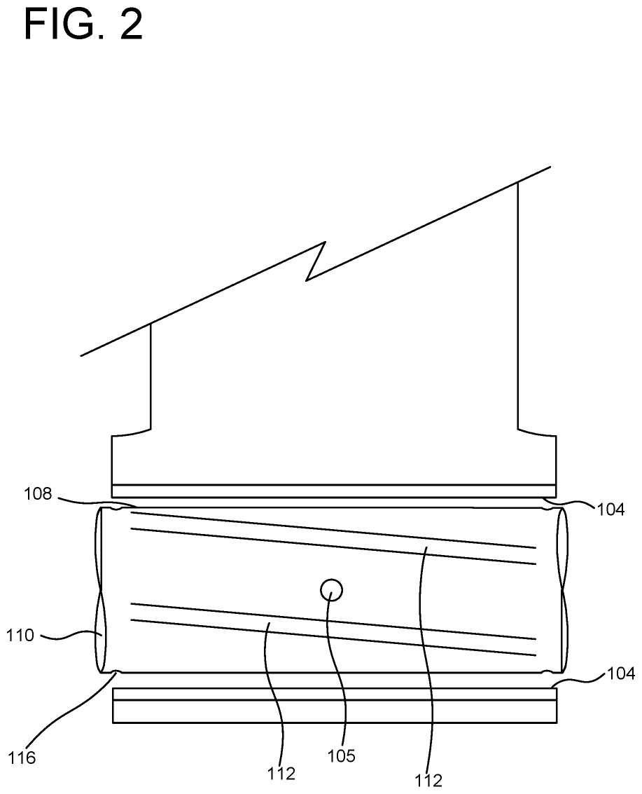

An exemplary indented journal is depicted in FIGS. 1 and 2. (FIG. 1 is an end view of a rod bearing/journal of a crankshaft connected to a piston via a connecting rod and FIG. 2 is a side view.) A piston 114 is connected to a crankshaft 110 through a connecting rod 102 at a rod bearing 100. In hydrodynamic operation (at operating rpm), a roughly uniform film of oil 103 separates the bearing surface 104 from the journal surface 108. The oil is provided through an oil passage 106 through the crankshaft and an oil hole 105 from the passage 106 to the gap between the surfaces 104, 108.

The journal surface 108 differs from the prior art in that it includes indentations 112 disposed on the surface 108 between the radiuses 116 of the journal. In one embodiment (e.g., a V8 engine), indentations 112 with a depth between roughly 1/1000 and 50/1000 of an inch are provided on the journal surface 108. The indentations 112 may be elongated, diagonally oriented (with respect to the crankshaft axis), and spaced evenly around the oil hole 105. In an alternative embodiment, the indentations take the form of pits. The indentations 112 may be provided on the journal surface 108 by, for example, cutting, machining, filing, stamping, or casting. In one embodiment, the indentations have a chamfer to provide a gradual leading lip and a gradual trailing edge (leading and trailing here are relative to the rotation of the crankshaft).

The indentations 112 are designed to collect and contain the oil (or other lubricant) to increase the oil volume and hydrodynamic state between the journal surface 108 and the bearing surface 104 in hydrodynamic operation. Further, the indentations 112 retain oil even when the crankshaft is idle, reducing oil starvation on start up. This will ease start-up stress when the crankshaft first starts turning, and thereby lower wear and tear on the journals/bearings.

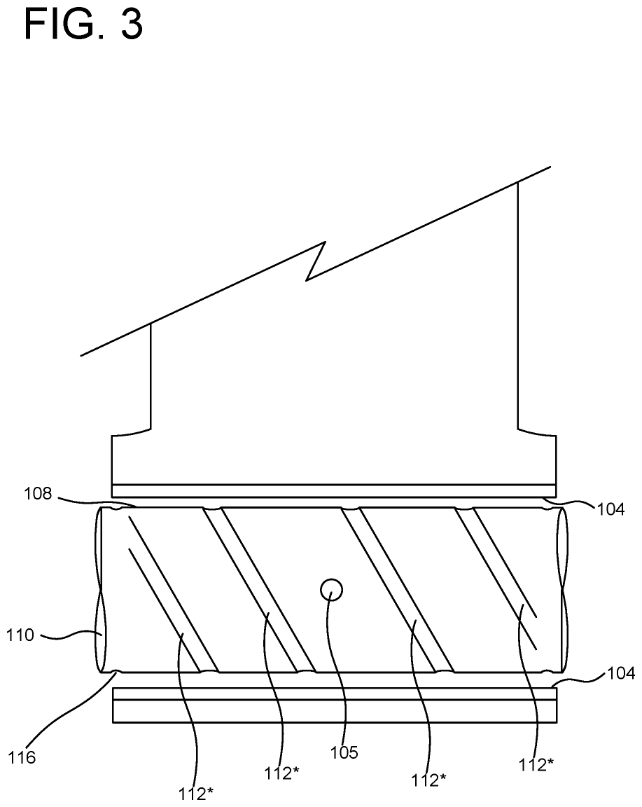

The exemplary embodiment depicted in FIG. 3 differs from that depicted in FIGS. 1 and 2 in the orientation of the elongated indentations. The indentations 112* in FIG. 3 include a circumferentially wrapped (wormed) groove.

While the foregoing description focused on rod bearings, the invention is not limited to rod bearings. It may be implemented in a variety of journal bearing. For example, the invention may be implemented in either rod or main bearings (or both) of a crankshaft in an internal combustion engine.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A journal bearing comprising:
(a) a bearing surface; and
(b) a journal surface;
(c) wherein the journal surface includes one or more indentations.

2. The journal bearing of claim 1 wherein the indentations are pits.

3. The journal bearing of claim 1 wherein the indentations are elongated grooves.

4. The journal bearing of claim 1 wherein the indentations are elongated and disposed on the journal surface diagonally to the longitudinal axis of the journal.

5. The journal bearing of claim 1 wherein the indentations have a depth between 1/1000 of an inch and 50/1000 of an inch.
